(19) United States
(12) Patent Application Publication
(10) Pub. No.: US 2002/0095318 A1
(43) Pub. Date: Jul. 18, 2002

(54) Electronic ticket squirting

(76) Inventor: Travis Parry, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/766,900

(22) Filed: Jan. 18, 2001

(51) Int. Cl. G06F 17/60

(52) U.S. Cl. 705/5

(57) ABSTRACT

This invention relates to electronic ticketing. Such structures of this type, generally, allow the user to squirt their travel ticket or the like from their personal digital assistant (PDA) instead of needing to get a printed copy. Also, this will allow the user to have a receipt of their travel ticket. If the user is checking baggage, the baggage claim tickets could be uploaded to the user's PDA. Once the user has an electronic copy of the travel tickets and the baggage claim tickets, the user can use this information for bookkeeping. Finally, the airline, for example, could also provide a service to allow the user to wirelessly receive information on the baggage as well as flight information.

### FIELD OF THE INVENTION

This invention relates to electronic ticketing. Such structures of this type, generally, allow the user to squirt their travel ticket or the like from their personal digital assistant (PDA) instead of needing to get a printed copy. Also, this will allow the user to have a receipt of their travel ticket. If the user is checking baggage, the baggage claim tickets could be uploaded to the user's PDA. Once the user has an electronic copy of the travel tickets and the baggage claim tickets, the user can use this information for bookkeeping. Finally, the airline, for example, could also provide a service to allow the user to wirelessly receive information on the baggage as well as flight information.

### DESCRIPTION OF THE RELATED ART

Currently when using an electronic airline ticket, it is stored only on the airline database. After checking in, the airline will provide the user with a printed copy that is subsequently scanned by the gate agent when the user boards the airplane. While this method eliminates the preparation of a paper ticket that may be lost prior to the travel date, the user must still rely upon the airline for the flight information. Also, the user cannot currently receive up-to-date information regarding his/her baggage or flight information.

It is known, in the travel industry, to employ a variety of tickets for use in travel. Exemplary of such prior art are U.S. Pat. No. 5,504,321 ('321) to D.P. Sheldon, entitled “Ticketless Travel Card and Method of Use,” U.S. Pat. No. 5,943,651 ('651) to S. Oosawa, entitled “Automatic Airline Ticket Issuer and Entry Card Creating System,” and U.S. Pat. No. 6,101,477 ('477) to W. Hohle et.al., entitled “Methods and Apparatus for a Travel-Related Multi-Function Smartcard.” While the '321, '651, and '477 references discuss the use of a variety of tickets, none of the references disclose the use of a personal digital assistant (PDA) to wirelessly store the ticket information, wirelessly retrieve the ticket information, wirelessly squirt the ticket information, and wirelessly update the ticket information.

It is also known, in the travel industry, to employ electronic ticketing. Exemplary of such prior art are U.S. Pat. No. 5,724,520 ('520) to J. R. Goheen, entitled “Electronic Ticketing and Reservation System and Method,” U.S. Pat. No. 5,953,705 ('705) to H. Oneda, entitled “Ticketless System and Processing Method and Memory Medium Storing Its Processing Program,” and U.S. Pat. No. 6,094,640 ('640) to J. R. Goheen, entitled “Electronic Ticketing and Reservation System and Method.” While the '520, '705, and '640 references disclose electronic ticketing, none of these references disclose the use of a PDA to wirelessly store the ticket information, wirelessly retrieve the ticket information, wirelessly squirt the ticket information, and wirelessly update the ticket information.

It is further known, in the travel industry, to employ baggage receiving and handling systems. Exemplary of such prior art are U.S. Pat. No. 5,793,639 ('639) to M. Yamazaki, entitled “Baggage Receiving and Handling Method in Airport, Baggage Receiving and Handling System in Airport, and Baggage Automatic Handling Apparatus,”U.S. Pat. No. 6,044,353 ('353) to A. V. Pugliese, III, entitled “Baggage Check-in and Security System and Method,” and U.S. Pat. No. 6,108,636 ('636) to C. H. E. Yap et.al., entitled “Luggage Handling and Reconciliation System Using an Improved Security Identification Document Including Contactless Communication Insert Unit.” While the '639, '353, and '636 references are concerned with baggage receiving and handling systems, none of the references disclose the use of a PDA to wirelessly store the baggage information, wirelessly retrieve the baggage information, wirelessly squirt the baggage information, and wirelessly update the baggage information.

Finally, it is known, in the travel industry, to employ portable travel service management devices. Exemplary of such prior art are U.S. Pat. No. 4,298,793 ('793) to J. H. A. M. Melis et.al., entitled “Portable Element for Receiving, Storing, Displaying and Outputting Digital Data, and a Reservation Device for Use in a Reservation System,” U.S. Pat. No. 5,832,451 ('451) to W. L. Flake et.al., entitled “Automated Travel Service Management Information System,” U.S. Pat. No. 5,948,040 ('040) to D. M. DeLorme et.al., entitled “Travel Reservation Information and Planning System,” U.S. Pat. No. 5,978,770 ('770) to W. Wayneta et.al., entitled “Assigning and Managing Patron Reservations for Distributed Services Using Wireless Personal Communication Devices,” and U.S. Pat. No. 6,122,642 ('642) to F. Mehovic, entitled “System for Propagating, Retrieving and Using Transaction Processing Facility Airline Computerized Reservation System Data on a Relational Database Processing Platform.” While the '793, '451, '040, '770, and '642 references employ portable travel service management devices, none of these references disclose the use of a PDA to wirelessly store the information, wirelessly retrieve the information, wirelessly squirt the information, and wirelessly update the information.

It is apparent from the above that there exists in the art for an electronic ticketing/baggage handling system which is portable, and which at least equals the ticketing/baggage handling characteristics of the known systems, but which the same time is capable of wirelessly storing the information, wirelessly retrieving the information, wirelessly squirting the information, and wirelessly updating the information. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for electronic ticket information squirting, comprising the steps of: inputting user identification information; wirelessly retrieving event information;

wirelessly retrieving an electronic event ticket; and wirelessly squirting the electronic event ticket to a ticket agent. In certain preferred embodiments, the event information can be a travel itinerary, an entertainment itinerary or the like. Also, the event ticket can be a travel ticket, an entertainment ticket or the like. Finally, a baggage claim check can be electronically retrieved and squirted.

In another further preferred embodiment, the electronic ticket information squirting eliminates the need for paper copies of the event ticket. Also, the electronic ticket information squirting provides an update of the event/baggage information.

The preferred electronic ticket, according to this invention, offers the following advantages: ease-of-use; elimination of the paper ticket; updating of event/baggage information; reduced risk of loss; and excellent economy. In fact, in many of the preferred embodiments, these factors of ease-of-use, elimination of the paper ticket, updating of event/baggage information, and reduced risk of loss are optimized to an extent that is considerably higher than heretofore achieved in prior, known electronic tickets.

The above and other features of the present invention, which will become more apparent as the description proceeds, are best understood by considering the following detailed description in conjunction with the accompanying drawings, and wherein like characters represent like parts throughout the several views and in which:

### BRIEF DESCRIPTION OF THE DRAWINGS

FIG. 1 is a flowchart that illustrates a method for electronic ticket information squirting, according to one embodiment of the present invention; and

FIG. 2 is a flowchart that illustrates a method for electronic baggage management, according to one embodiment of the present invention.

### DETAILED DESCRIPTION OF THE INVENTION

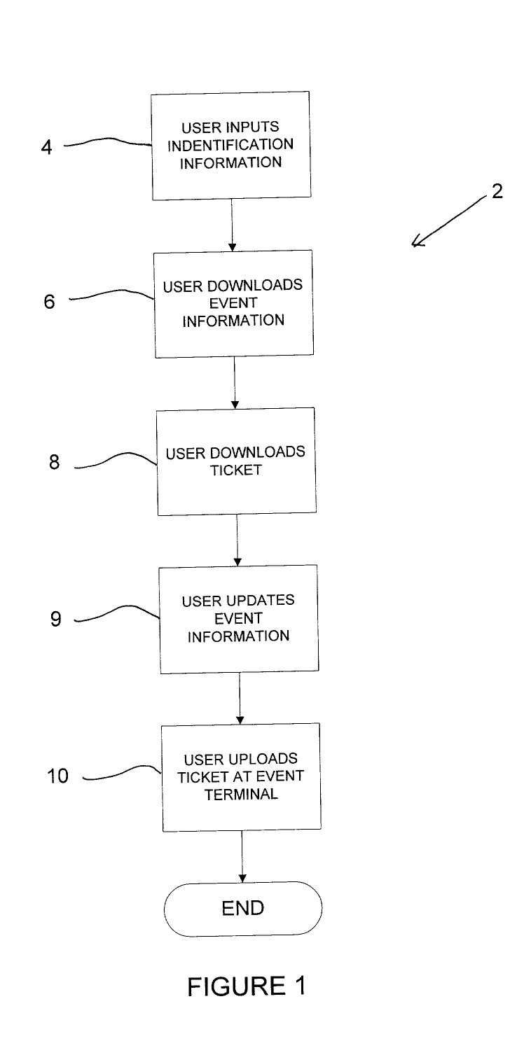

With reference first to FIG. 1, there is illustrated one preferred embodiment for use of the concepts of this invention. In particular, method 2 for electronic ticket information squirting is illustrated. With respect to method 2, the user inputs identification information into a personal communication device (PCD), as shown in step 4. A PCD can be, but is not limited to, a personal digital assistant (PDA) or the like which is wirelessly connected to a variety of Internet Web sites. The identification information can be, but is not limited to, a password or the like.

After the user has conventionally logged into an event service, the user can wirelessly download event information, as shown in step 6. In the example shown in FIG. 1, the user is wirelessly downloading travel information. However, it is to be understood that the term “event” can refer to, but is not limited to, travel, entertainment or the like. For example, “event” can refer to a trip, a concert, a movie, or the like. After the user has reviewed the event information, the user can wirelessly download an electronic ticket to the event on the PCD, as shown in step 8.

Once the user has retained the electronic ticket in the PCD, the user merely has to electronically/wirelessly squirt the electronic ticket information to the ticket agent at the event site on the day of the event, as shown in step 10. It is to be understood that the term “squirt” refers to the transmitting of a modulated carrier medium from the PCD to a receiver operated by the ticket agent that is capable of detecting/reading the modulated carrier medium. The carrier medium is modulated in such a way as to include computer-executable instructions related to the electronic ticket.

Finally, the user can wirelessly check the status of the event, as shown in step 9. For example, the user can check the status of the flights, the status of the movie, the status of the concert or the like through the Internet Web site used to purchase the electronic ticket.

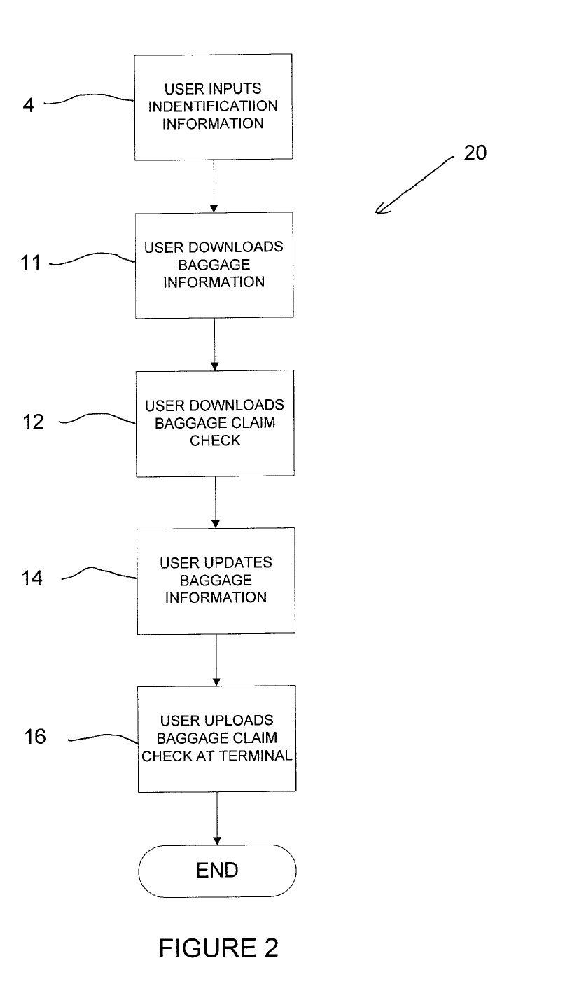

It is to be understood that method 20 could also be used to keep track of baggage. For example, as shown in FIG. 2, the user inputs identification information, as shown in step 4, as previously discussed above. The user wirelessly downloads baggage information into the PCD, as shown in step 11. The user then wirelessly receives an electronic baggage claim check or claim checks, as shown in step 12. This baggage claim check information is stored in the PCD. The user electronically/wirelessly squirts the electronic baggage claim check information to the ticket agent at the travel terminal on the date of travel, as shown in step 16. Finally, the user can wirelessly check the status/location of the baggage throughout the travel, as shown in step 14 through the Internet Web site used to register the claimed baggage.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for electronic ticket information squirting, wherein said method is comprised of the steps of:
inputting user identification information;
wirelessly retrieving event information;
wirelessly retrieving an electronic event ticket; and
wirelessly squirting said electronic event ticket to a ticket agent.

2. The method, as in claim 1, wherein said method is further comprised of the step of:
performing said electronic ticket information squirting on a personal communication device (PCD).

3. The method, as in claim 2, wherein said personal communication device is further comprised of:
a personal digital assistant (PDA).

4. The method, as in claim 1, wherein said event information is further comprised of:
a travel itinerary.

5. The method, as in claim 1, wherein said event information is further comprised of:
an entertainment itinerary.

6. The method, as in claim 1, wherein said method is further comprised of the step of:
monitoring said event information.

7. A method for electronic baggage information squirting, wherein said method is comprised of the steps of:
inputting user identification information;
wirelessly retrieving baggage information;
wirelessly retrieving an electronic baggage claim check; and
wirelessly squirting said electronic baggage claim check to a ticket agent.

8. The method, as in claim 7, wherein said method is further comprised of the step of:
performing said electronic baggage information squirting on a personal communication device (PCD).

9. The method, as in claim 8, wherein said personal communication device is further comprised of:
a personal digital assistant (PDA).

10. The method, as in claim 7, wherein said method is further comprised of the step of:
monitoring said baggage information.

11. A computer-readable medium having computer-executable instructions for the method recited in claim 1.

12. A computer-readable medium having computer-executable instructions for the method recited in claim 7.

13. A program storage medium readable by a computer, tangibly embodying a program of instructions executable by the computer to perform method steps for electronic ticket squirting, said method steps comprising:
inputting user identification information;
wirelessly retrieving event information;
wirelessly retrieving an electronic event ticket; and
wirelessly squirting said electronic event ticket to a ticket agent.

14. The method, as in claim 13, wherein said method is further comprised of the step of:
monitoring said event information.
